(19) United States
(12) Patent Application Publication
(10) Pub. No.: US 2012/0331010 A1
(43) Pub. Date: Dec. 27, 2012

(54) Systems And Methods For Performing A Query On A Distributed Database

(76) Inventor: Douglass Adam Christie, Morrisville, NC (US)

(21) Appl. No.: 13/273,875

(22) Filed: Oct. 14, 2011

Related U.S. Application Data
(63) Continuation-in-part of application No. 13/168,424, filed on Jun. 24, 2011.

(51) Int. Cl. G06F 17/30

(52) U.S. Cl. 707/802; 707/E17.005

(57) ABSTRACT

Systems and methods are provided for performing a query in a distributed system. In one example, a query processor receives an instruction to perform a database operation involving a query. Based on an identification of a correlated subquery within the query, the query processor modifies the correlated subquery by replacing at least one correlated variable with a parameter or updatable constant. The modified subquery is sent to an external database for execution, where the external database is identified in the correlated subquery. The results of the modified subquery are received at the query processor from the external database and are used to execute the query. The correlated subquery includes a conditional relationship between a column in a first set of data and a column in a second set of data, wherein the first and second sets of data are stored in different external databases.

### CROSS-REFERENCE TO RELATED APPLICATIONS

This application is a continuation-in-part of U.S. patent application Ser. No. 13/168,424, filed on Jun. 24, 2011, and titled “Systems and Methods for Performing Index Joins Using Auto Generative Queries, the entirety of which is incorporated herein by reference.

### FIELD

The technology described in this patent document relates generally to computer-implemented database systems.

### BACKGROUND

In the field of query processing, tables can often be stored on multiple databases, as illustrated in FIG. 1. To process a query, tables are typically copied from each database, and any data manipulations or comparisons are then performed in a local memory space. Moving an entire table from one database to another in order to perform an operation, such as a join operation, can be very resource and time intensive. As an example, consider the example database system illustrated in FIG. 1, where Table A is located in one foreign database and Tables B and C are located in another foreign database. Also consider the following query executed in the system illustrated in FIG. 1: “select * from table A inner join B on A.X=B.Y where exists (select * from C where A.X>C.Z)”. This example query includes not only a join operation, but also includes a correlated subquery involving a correlation between A.X and C.Z. As illustrated in FIG. 1, execution of this query would typically require all of the rows from Table C to be copied to the SQL processor for every execution of the subquery. For example, if a thousand rows from the join of Table A and Table B satisfy the expression X=Y, then the query “select * from C” is executed a thousand times, possibly requiring Table C to be copied to the SQL processor a thousand times.

### SUMMARY

In accordance with the teachings described herein, systems and methods are provided for performing a query in a distributed system. In one example, a query processor receives an instruction to perform a database operation involving a query. Based on an identification of a correlated subquery within the query, the query processor modifies the correlated subquery by replacing at least one correlated variable with a parameter. The modified subquery is sent by the query processor to an external database for execution, where the external database is identified in the correlated subquery. The results of the modified subquery are received at the query processor from the external database, and the query processor uses the results to execute the query. The correlated subquery includes a conditional relationship between a column in a first set of data and a column in a second set of data, wherein the first and second sets of data are stored in different external databases.

In another example, a system or method for performing a query in a distributed database system may execute the following steps: (a) receiving, at a query processor, an instruction to perform a database operation involving an outer query and a subquery, the subquery including a conditional relationship between a column in a first set of data and a column in a second set of data, wherein the first and second sets of data are stored in separate external databases; (b) automatically modifying the subquery to generate a modified subquery by replacing the column in the first set of data with a parameter or updatable constant; (c) substituting a value from a row of the first set of data for the parameter or updatable constant; (d) causing the modified subquery to be executed by the external database to identify one or more rows from the second set of data that satisfy the modified subquery; (e) receiving, at the query processor, results of the modified subquery from the external database; and (f) repeating steps (c), (d) and (e) for each row in the first set of data

### BRIEF DESCRIPTION OF THE DRAWINGS

FIG. 1 is a block diagram of a typical system for performing a subquery operation in a federated database.

FIG. 2 is block diagram of an example system for performing a query in a distributed database system.

FIG. 3 illustrates another example system for performing a query in a distributed database system where one or more databases do not support parameters.

FIGS. 4-6 provide an example to further illustrate the operation of the systems of FIGS. 2 and 3.

FIGS. 7-13 illustrate another example query.

FIGS. 14 and 15 are flow diagrams illustrating example methods for performing a query in a distributed database system.

FIGS. 16A, 16B, and 16C depict examples of systems that may be used to perform a query in a distributed database system.

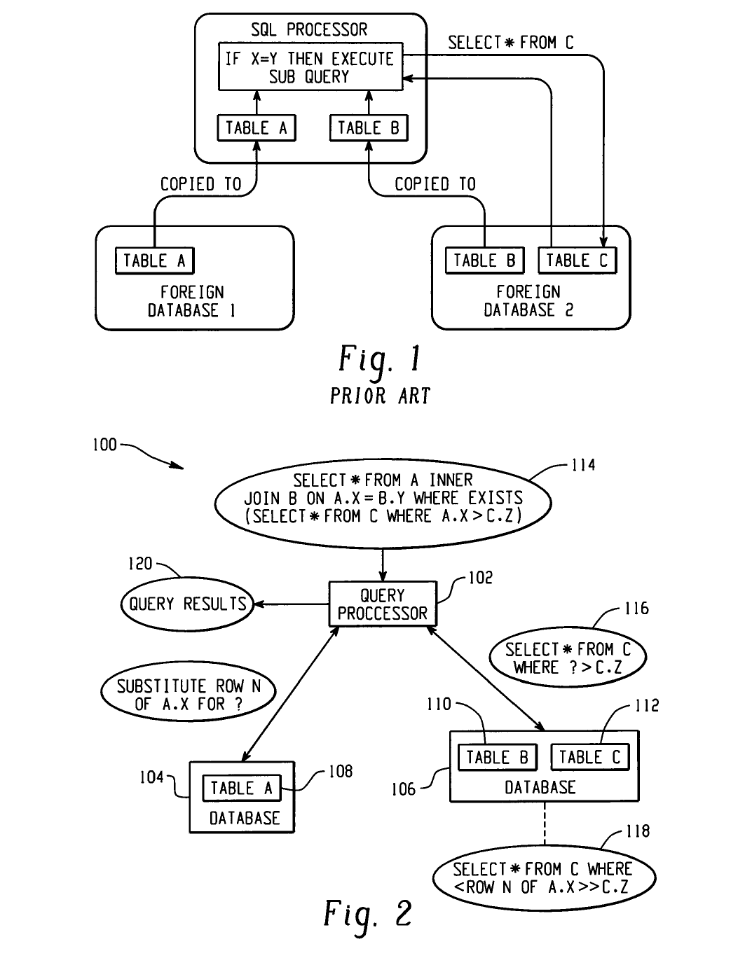

### DETAILED DESCRIPTION

FIG. 2 is block diagram of an example system 100 for performing a query in a distributed database system. The system 100 includes a query processor 102 and one or more distributed databases 104, 106 for storing data tables 108, 110, 112. The query processor 102 and the databases 104, 106 may, for example, be included in a federated database system. For instance, the query processor 102 may be an SQL processor executing within a database management system.

In operation, the query processor 102 utilizes parameters in order to push portions of a subquery operation to the database 106 by substituting, in place of a correlated column of the subquery, a parameter that can be updated for each row of the parent query. After the row is updated with the value from the column of the parent query, the query processor then re-executes the query against the database 106. Specifically, in the illustrated embodiment, the query processor receives an instruction 114 to perform a database operation involving an outer query between a column of data in Table A and a column of data in Table B. The received instruction 114 further includes a subquery that defines a conditional relationship between the column of data in Table A and a column of data in Table C. The query processor 102 then automatically modifies the subquery by replacing the conditional expression with a parameterized clause, and then submits the modified subquery 116 to the database 106. For instance, the query processor 102 may modify the subquery by replacing the correlated column of data in Table A with the parameter “?”.

If the database 106 accepts the modified subquery 116, then the query processor 102 causes a value from the correlated column of data in Table A 108 to be substituted for the parameter. For example, the value may be copied into a memory space allocated at the query processor 102, and the query processor 102 may provide the memory address to the database 106 so that the value may be retrieved by the database 106 and substituted for the parameter in the modified subquery 116. The subquery with the substituted value 118 is then executed against Table C and the results are returned to the query processor 102 for use in performing the outer query and generating the query results 120.

To help illustrate the operation of the system 100 shown in FIG. 2, consider the example join expression, “select * from A inner join B on A.X=B.Y where exists (select * from C where A.X>C.Z)”, which is input to the query processor 102. In this example, the query processor 102, upon detecting the subquery, automatically modifies the subquery to replace the correlated column, A.X, with the parameter “?”, as follows:
select * from C where ?>C.Z
   The where clause in the above subquery defines a conditional relationship (>) between column C.Z and the parameter “?”. If the parameterized subquery is accepted by the database 106, then the query processor 102 can cause values from each row for the column A.X from Table A 108 to be substituted for the parameter “?”, and cause the query with each substituted value to be executed on Table C. An example of this substitution process is described below with reference to FIGS. 4-6.

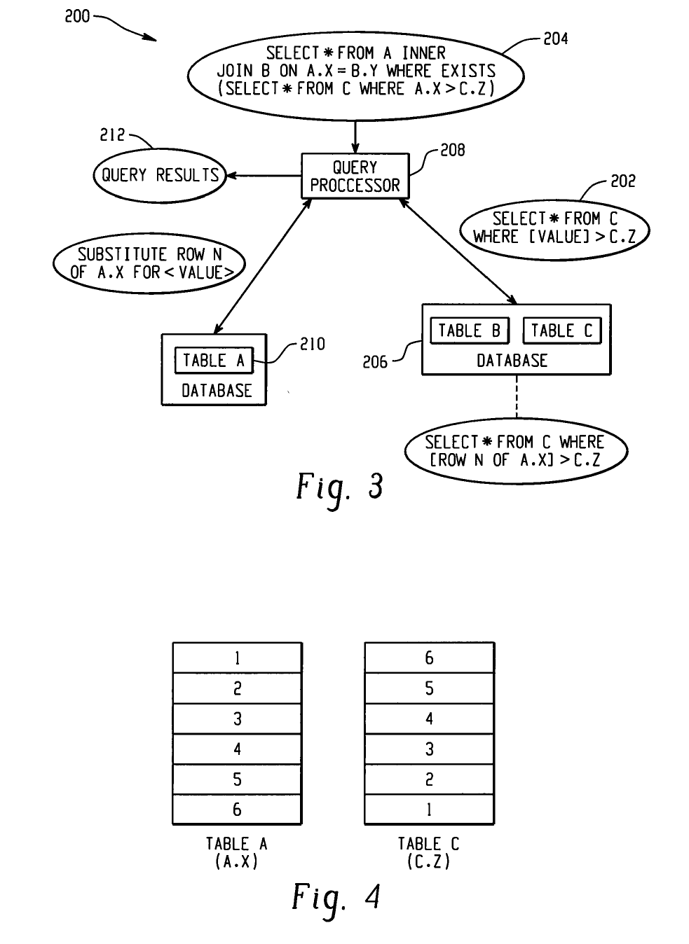

FIG. 3 illustrates another example system 200 for performing a query in a distributed database system where one or more databases do not support parameters. In this situation, an updatable constant may be used in the modified subquery 202 instead of a parameter. For instance, upon receiving a query 204 that includes a subquery on a database 206 that does not support parameters, the query processor 208 allocates a memory location for an updateable constant value and then automatically generates, in an internal query form, a subquery 202 that replaces a correlated column in the original subquery with the updatable constant value. The modified subquery 202 is then executed for each row from the correlated table 210, with the row from the correlated table 210 being fetched and substituted for the updatable constant within the allocated memory location

To help illustrate the operation of the system 200 of FIG. 3, consider again the example expression “select * from A inner join B on A.X.=B.Y where exists (select * from C where A.X.>C.Z).” Upon receiving this expression 204, detecting the subquery, and detecting that database 206 does not support parameters, the query processor 208 automatically generates a new subquery 202 in an internal query form, as follows:
select * from C where <value>>C.Z
   The where clause in the above subquery defines a conditional relationship (>) between column C.Z and the updatable constant <value>, where <value> points within the internal query form to an allocated memory location. The query processor 208 can then substitute values from each row of column A.X of Table A 210 for the updatable constant, and cause the subquery to be executed on Table C, only returning rows that satisfy the where clause. The results of the subquery 202 may then be used to perform the outer query and generate the query results 212.

FIGS. 4-6 provide an example to further illustrate the operation of the systems of FIGS. 2 and 3. The example shown in FIGS. 4-6 again illustrates operation using the example subquery, “select * from C where A.X>C.Z.” For the purposes of the example, the tables (A and C) that are correlated in the subquery each include one column with six rows containing integers, as illustrated in FIG. 4. As explained above with reference to FIGS. 2 and 3, upon receiving the query “select * from table A inner join B on A.X.=B.Y where exists (select * from C where A.X>C.Z)”, the query processor will automatically generate a modified subquery by replacing the correlated column A.X with a parameter or updatable constant.

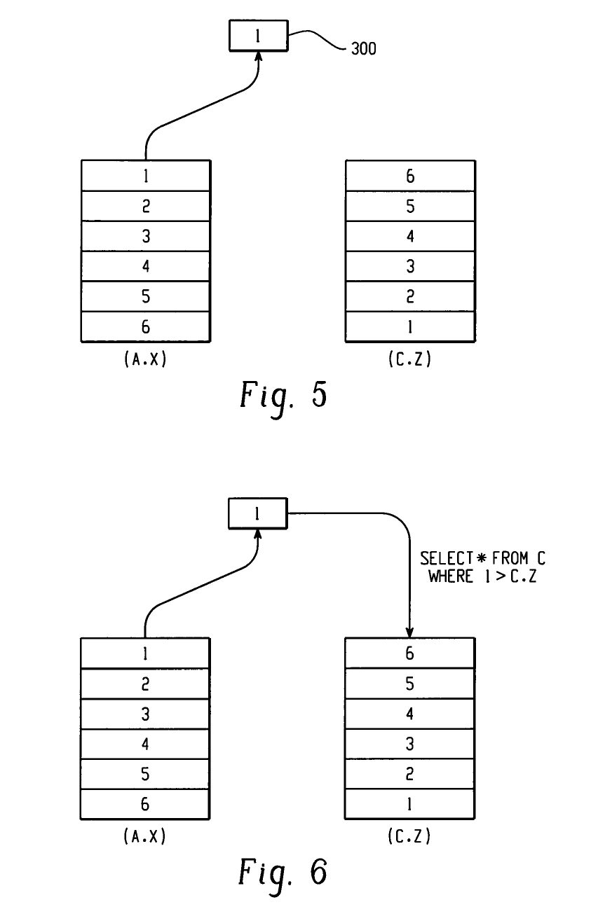

As shown in FIG. 5, a memory location 300, such as an address space, is allocated for the parameter or updatable constant. The first row value from the correlated column A.X is then fetched and copied into the parameter or updatable constant memory location 300. In the illustrated example, the integer value of “1” is copied from the first row of A.X into the allocated memory location 300. The fetched value (“1”) may then be substituted for the parameter or updatable constant and the subquery may be executed against the database, as shown in FIG. 6. Specifically, in the illustrated example the fetched integer value “1” is substituted for the parameter or updatable constant to execute the subquery, “select * from C where 1>C.Z”, on the database. The result(s) of the subquery are then returned from the database to the query subprocessor, and the process shown in FIGS. 5 and 6 is repeated for each row in A.X.

It should be understood that in the case where the query includes an “exists” condition, as in the example query discussed herein, the query processor will only check with the database to determine if matching rows exist in C.Z. For instance, in the example shown in FIG. 6, the results of the subquery will return a true condition because there is an integer greater than 1 that exists in C.Z. In other examples, however, the query processor may fetch rows from the database that are returned from a subquery executed by the database. In either situation, replacement of the correlated column in the original subquery with a parameter or updatable constant to enable the subquery to be pushed to the database, may significantly reduce the amount of required data movement across the network.

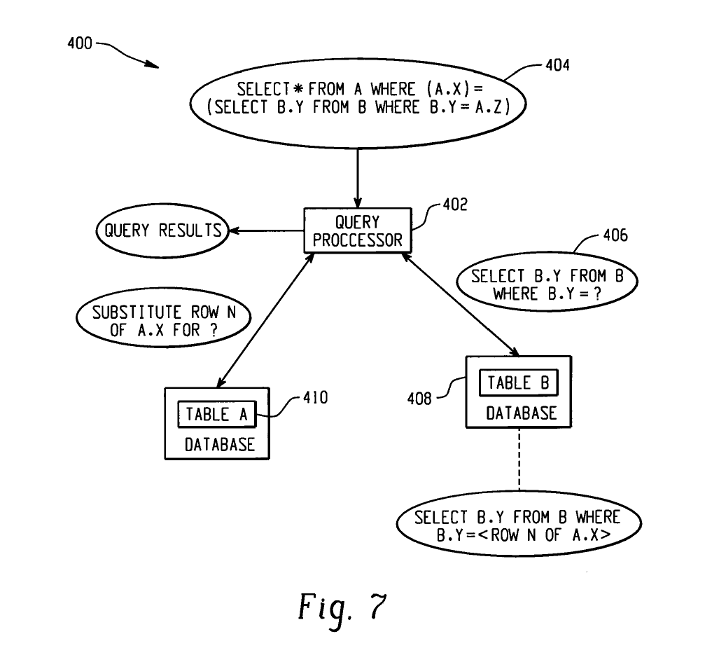

FIG. 7 is a block diagram of another example query performed by the system described above with reference to FIG. 2. In this example, the query processor 402 receives an instruction 404 to perform a database operation that includes a subquery that defines a conditional relationship between a column of data in Table A and a column of data in Table B. Specifically, in the illustrated example, the query processor 402 receives the query, “select * from A where (A.X)=(select B.Y from B where B.Y=A.Z).” Upon detecting the subquery, “select B.Y from B where B.Y=A.Z,” the query processor 402 automatically modifies the subquery by replacing the conditional expression with a parameterized where clause, and then submits the modified subquery 406 to the database 408. In the illustrated example, the query processor 402 modifies the subquery by replacing the correlated column A.Z from Table A with the parameter “?”, as follows:
select B.Y from B where B.Y=?
   The where clause in the above subquery defines a conditional relationship (=) between column B.Y and the parameter “?”. If the parameterized subquery is accepted by the database 408, then the query processor 402 causes values from each row from column A.Z from Table A 410 to be substituted for the parameter “?” in the processor 402, and causes the query with each substituted value to be executed on Table B.

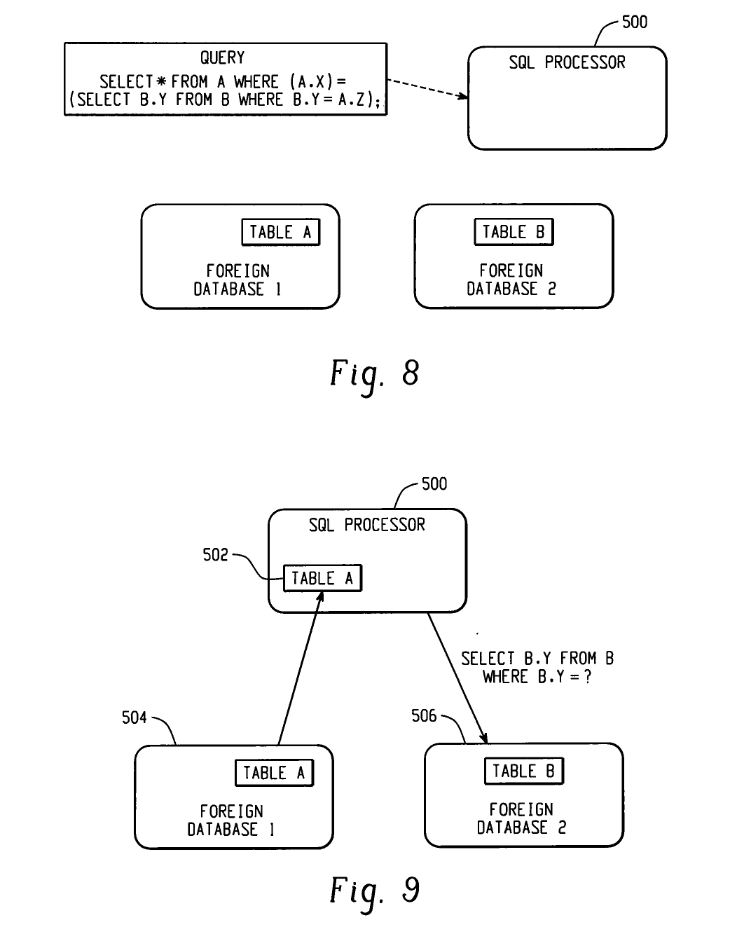

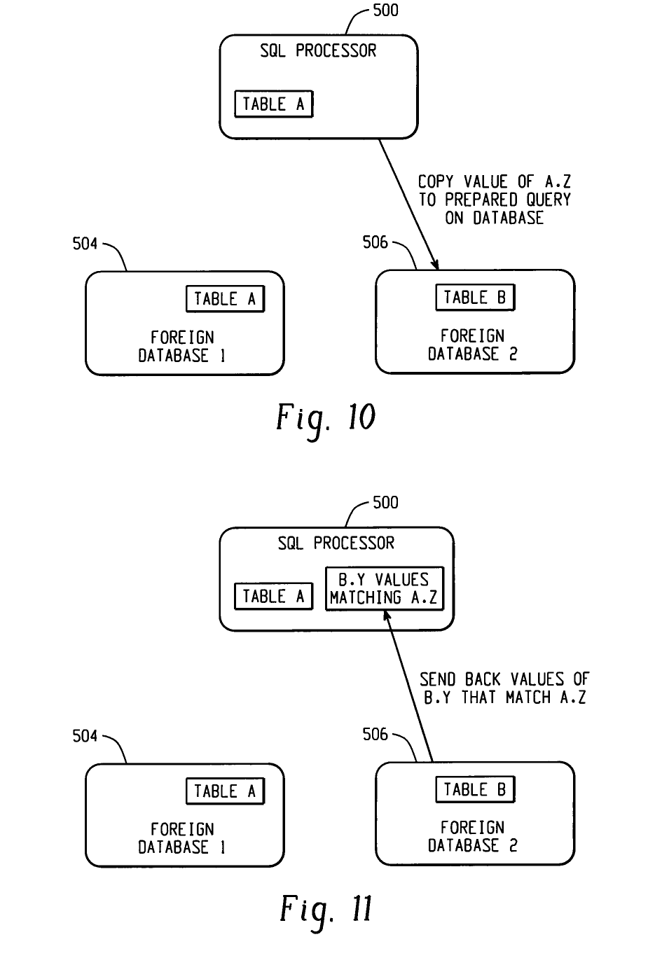

FIGS. 8-13 further illustrate the operation of the system shown in FIG. 7. The example shown in FIGS. 8-13 again illustrates operation using the example query, “select * from A where (A.X)=(select B.Y form B where B.Y=A.Z).” FIG. 8 illustrates receipt of the example query by the query processor 500, which as shown in this example may be an SQL processor. As illustrated in FIG. 9, in response to the query, the query processor 500 retrieves the identified table data 502 from the first database 504. In addition, upon detecting the subquery, the query processor 500 replaces the conditional expression in the subquery with a parameterized clause to generate the modified subquery, “select B.Y from B where B.Y=?.” The modified subquery is then submitted to the second database 506. If the parameterized subquery is accepted by the database 506, then the query processor 500 copies the values from each row from column A.Z to the space allocated for the parameter “?” in the processor 500. FIG. 10 illustrates a value from column A.Z being copied by the database 506 from the query processor 500 to the prepared query on the database 506. The database 506 then executes the query, with the table value from column A.Z substituted for the parameter, and returns the query result to the query processor 500, as illustrated in FIG. 11.

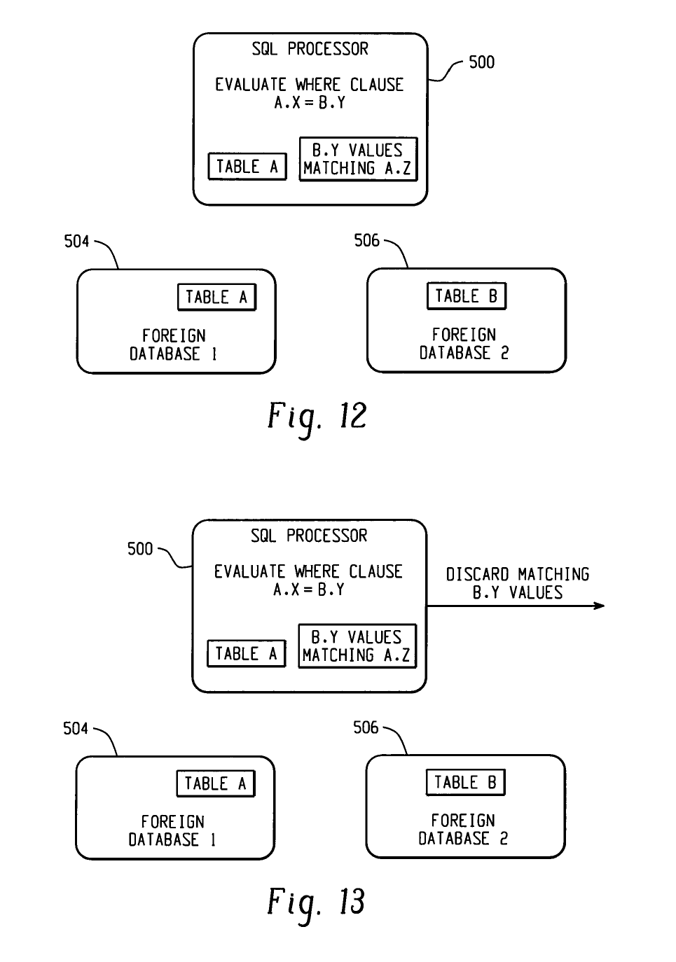

As shown in FIG. 12, the query processor 500 then uses the subquery results from the database 506 to evaluate the outer query, “A. X=B.Y.” After which, the subquery results are flushed, as shown in FIG. 13, and the process is repeated (starting at FIG. 9) for each row in column A.Z.

It should be understood that the example illustrated in FIGS. 7-13 could also be performed using an updatable constant instead of a parameter, for instance as described above with reference to FIG. 3.

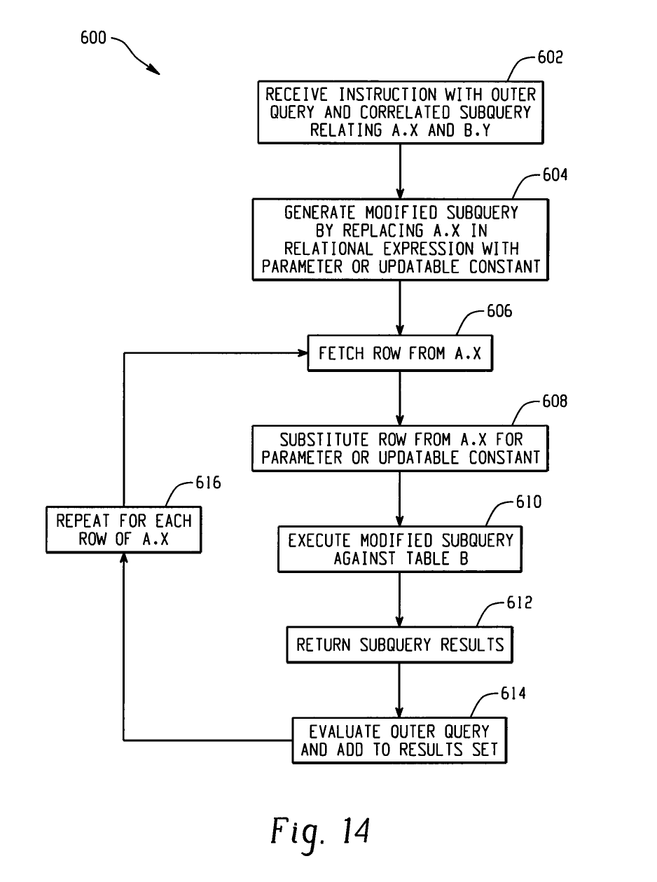

FIG. 14 is a flow diagram depicting an example method 600 for performing a query in a distributed database system. At 602, an instruction is received to perform a database operation involving an outer query and a subquery that includes a conditional relationship between a column in a first set of data (e.g., A.X) and a column in a second set of data (e.g., B.Y). A modified subquery is then generated at 604 by replacing the column in the first set of data with a parameter or updatable constant.

At 606, a row is fetched from the correlated column in the first set of data (e.g., A.X.), and the fetched value is substituted for the parameter or updatable constant at 608. The modified subquery is then executed by the external database at 610 to identify one or more rows from the second set of data that satisfy the modified subquery. The result(s) of the modified subquery are returned to the query processor at 612. The subquery results are used to execute the outer query at 614. Steps 606-614 are then repeated for each row in the first set of data.

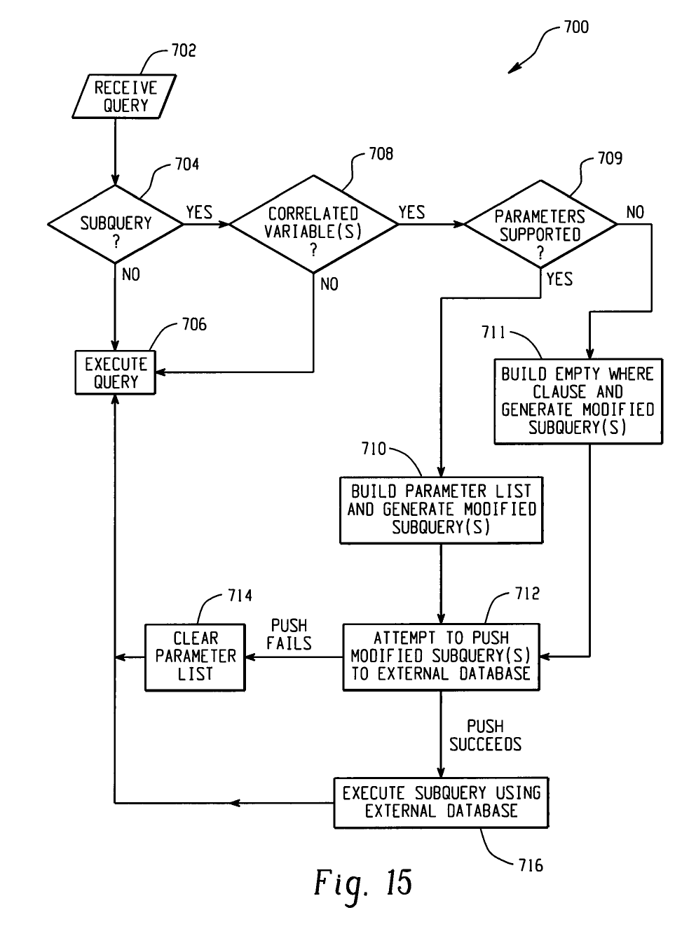

FIG. 15 is a flow diagram depicting another example method 700 for performing a query in a distributed database system. At 702, an instruction is received that includes a database query. The query is then evaluated at 704 to determine if it includes one or more subqueries. If no subquery is detected, then the method proceeds to 706, where the query is executed on the database(s) in a typical fashion (e.g., without using parameters). Otherwise, if one or more subqueries are detected at 704, then the method proceeds to 708.

At 708, the query is processed to identify one or more correlated subqueries. If no correlated subqueries are identified, the method proceeds to 706 and the query is processed in a typical fashion (e.g., without using parameters.) Otherwise, if one or more correlated subqueries are identified, then the method proceeds to 709. At 709, the method determines if the database(s) on which the query is to be executed supports parameters. If so, then the method proceeds to 710. If parameters are not supported, then the method proceeds to 711.

At 710, a parameter list is established to provide a parameter for each correlated variable that is identified within the one or more correlated subqueries, and a modified subquery is generated by replacing the one or more correlated variables in the received query with the parameters from the parameter list. For instance, in the example described above with reference to FIG. 2, a single correlated subquery (“select * from C where A.X>C.Z”) would be identified in the received query, and a parameter list would be established to provide a parameter (“?”) for the correlated variable (“A.X”). In other examples, however, the query may include more than one correlated subquery and/or more than one correlated variable.

At 711, an empty where clause is created to support an updateable constant value, and a modified subquery is generated by replacing the one or more correlated variables in the received query with the updatable constant. For instance, in the example described above with reference to FIG. 3, a single correlated subquery (“select * from C where A.X>C.Z”) would be identified in the received query, and the updatable constant (“<value>”) would be substituted for the correlated variable (“A.X”). In other examples, however, the query may include more than one correlated subquery and/or more than one correlated variable.

At 712, an attempt is made to push the modified subquery to the external database for processing. If the push fails, then the parameter list at is cleared at 714 (if the database supports parameters) and the method proceeds to 706 and the query is processed in a typical fashion. If the push succeeds, however, then the one or more correlated subqueries are executed on the external database at 716, for example using the method of FIG. 14.

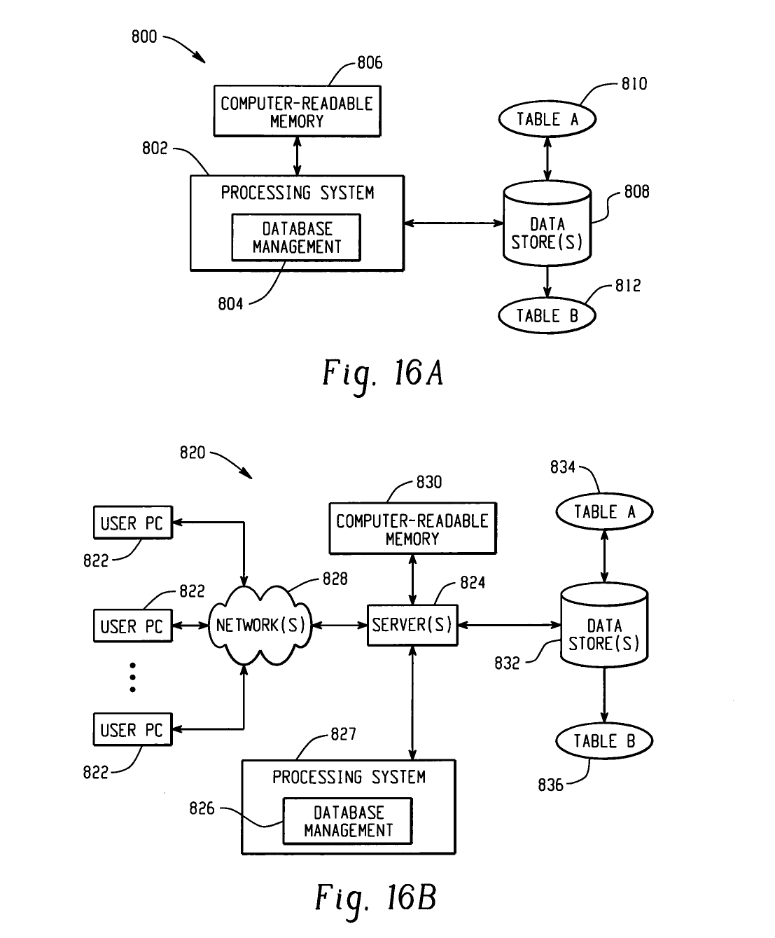

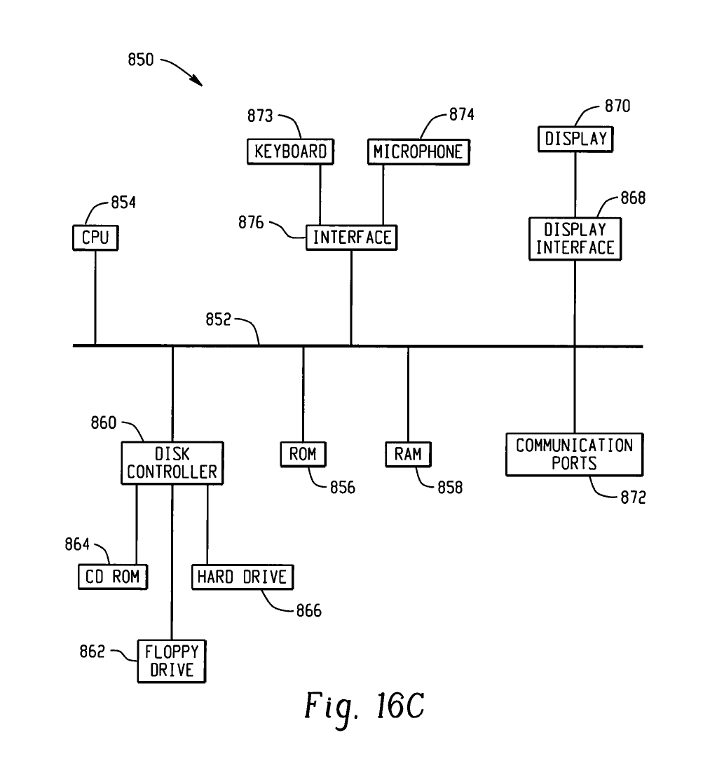

FIGS. 16A, 16B, and 16C depict examples of systems that may be used to perform a query in a distributed database system. For example, FIG. 16A depicts an example of a system 800 that includes a standalone computer architecture where a processing system 802 (e.g., one or more computer processors) includes a database management application 804 being executed on it. The processing system 802 has access to a computer-readable memory 806 in addition to one or more data stores 808. The one or more data stores 808 may include tables 810, 812 upon which the query operation is to be performed.

FIG. 16B depicts a system 820 that includes a client server architecture. One or more user PCs 822 access one or more servers 824 running a database management program 826 on a processing system 827 via one or more networks 828. The one or more servers 824 may access a computer readable memory 830 as well as one or more data stores 832. The one or more data stores 832 may contain tables 834, 836 upon which the query operation is to be performed.

FIG. 16C shows a block diagram of an example of hardware for a standalone computer architecture 850, such as the architecture depicted in FIG. 16A that may be used to contain and/or implement the program instructions of system embodiments of the present invention. A bus 852 may connect the other illustrated components of the hardware. A processing system 854 labeled CPU (central processing unit) (e.g., one or more computer processors), may perform calculations and logic operations required to execute a program. A processor-readable storage medium, such as read only memory (ROM) 856 and random access memory (RAM) 858, may be in communication with the processing system 854 and may contain one or more programming instructions for performing an index join operation. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. Preferably, the processor 854 may access each component as required.

A display interface 868 may permit information from the bus 852 to be displayed on a display 870 in audio, graphic, or alphanumeric format. Communication with external devices may optionally occur using various communication ports 872.

In addition to the standard computer-type components, the hardware may also include data input devices, such as a keyboard 873, or other input device 874, such as a microphone, remote control, pointer, mouse and/or joystick.

This written description uses examples to disclose the invention, including the best mode, and also to enable a person skilled in the art to make and use the invention. The patentable scope of the invention may include other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A method for performing a query in a distributed database system, comprising:
(a) receiving, at a query processor, an instruction to perform a database operation involving an outer query and a subquery, the subquery including a conditional relationship between a column in a first set of data and a column in a second set of data, wherein the first and second sets of data are stored in separate external databases;
(b) automatically modifying the subquery to generate a modified subquery by replacing the column in the first set of data with a parameter or updatable constant;
(c) substituting a value from a row of the first set of data for the parameter or updatable constant;
(d) causing the modified subquery to be executed by the external database to identify one or more rows from the second set of data that satisfy the modified subquery;
(e) receiving, at the query processor, results of the modified subquery from the external database; and
(f) repeating steps (c), (d) and (e) for each row in the first set of data.

2. The method of claim 1, further comprising:
performing the database operation at the query processor using the results of the modified subquery.

3. The method of claim 1, wherein the subquery includes a where expression that includes the conditional relationship between the column in the first set of data and the column in the second set of data.

4. The method of claim 1, wherein the outer query includes a join operation between columns in the first set of data and a third set of data.

5. The method of claim 1, wherein:
the subquery comprises, where A.X<RO>B.Y, wherein A.X is a first variable that identifies the column in the first set of data, <RO> is a relational operator, and B.Y is a second variable that identifies the column in the second set of data; and
the modified subquery comprises, where ?<RO>B.Y, wherein ? is the parameter.

6. The method of claim 1, wherein:
the subquery comprises, where A.X<RO>B.Y, wherein A.X is a first variable that identifies the column in the first set of data, <RO> is a relational operator, and B.Y is a second variable that identifies the column in the second set of data; and
the modified subquery comprises, where <value><RO>B.Y, wherein <value> is the updatable constant.

7. A method for performing a query in a distributed database system, comprising:
receiving, at a query processor, an instruction to perform a database operation involving a query;
based on an identification of a correlated subquery within the query, modifying the correlated subquery to generate a modified subquery by replacing at least one correlated variable with a parameter or updatable constant;
sending the modified subquery to an external database for execution, the external database being identified in the correlated subquery;
receiving, at the query processor, results of the modified subquery from the external database; and
executing the query, at the query processor, using the results received from the external database.

8. The method of claim 7, wherein the correlated subquery includes a conditional relationship between a column in a first set of data and a column in a second set of data, wherein the first and second sets of data are stored in different external databases.

9. The method of claim 8, wherein:
the correlated subquery comprises, where A.X<RO>B.Y, wherein A.X is a first variable that identifies the column in the first set of data, <RO> is a relational operator, and B.Y is a second variable that identifies the column in the second set of data; and
the modified subquery comprises, where ?<RO>B.Y, wherein ? is the parameter.

10. A system for performing a query in a distributed database system, comprising:
a processor;
a memory;
a database management application stored in the memory and executable by the processor, when executed, the database management application being configured to:
receive an instruction to perform a database operation involving a query;
based on an identification of a correlated subquery within the query, modify the correlated subquery to generate a modified subquery by replacing at least one correlated variable with a parameter;
send the modified subquery to an external database for execution, the external database being identified in the correlated subquery;
receive results of the modified subquery from the external database; and
execute the query using the results received from the external database.

11. The system of claim 10, wherein the correlated subquery includes a conditional relationship between a column in a first set of data and a column in a second set of data, wherein the first and second sets of data are stored in different external databases.

12. The system of claim 11, wherein:
the correlated subquery comprises, where A.X<RO>B.Y, wherein A.X is a first variable that identifies the column in the first set of data, <RO> is a relational operator, and B.Y is a second variable that identifies the column in the second set of data; and
the modified subquery comprises, where ?<RO>B.Y, wherein ? is the parameter.

13. A system for performing a query in a distributed database system, comprising:
a processor;
a memory;
a database management application stored in the memory and executable by the processor, when executed, the database management application being configured to:
(a) receive an instruction to perform a database operation involving an outer query and a subquery, the subquery including a conditional relationship between a column in a first set of data and a column in a second set of data, wherein the first and second sets of data are stored in separate external databases;
(b) automatically modify the subquery to generate a modified subquery by replacing the column in the first set of data with a parameter or updatable constant;
(c) substitute a value from a row of the first set of data for the parameter or updatable constant;
(d) cause the modified subquery to be executed by the external database to identify one or more rows from the second set of data that satisfy the modified subquery;
(e) receive results of the modified subquery from the external database; and
(f) repeat steps (c), (d) and (e) for each row in the first set of data.

14. The system of claim 13, wherein the database management system is further configured to perform the database operation at the query processor using the results of the modified subquery.

15. The system of claim 14, wherein the subquery includes a where expression that includes the conditional relationship between the column in the first set of data and the column in the second set of data.

16. The system of claim 13, wherein the outer query includes a join operation between columns in the first set of data and a third set of data.

17. The system of claim 13, wherein:
the subquery comprises, where A.X<RO>B.Y, wherein A.X is a first variable that identifies the column in the first set of data, <RO> is a relational operator, and B.Y is a second variable that identifies the column in the second set of data; and
the modified subquery comprises, where ?<RO>B.Y, wherein ? is the parameter.

18. The system of claim 13, wherein:
the subquery comprises, where A.X<RO>B.Y, wherein A.X is a first variable that identifies the column in the first set of data, <RO> is a relational operator, and B.Y is a second variable that identifies the column in the second set of data; and
the modified subquery comprises, where <value><RO>B.Y, wherein <value> is the updatable constant.
